(19) United States
(12) Patent Application Publication
(10) Pub. No.: US 2026/0100161 A1
(43) Pub. Date: Apr. 9, 2026

(54) DISPLAY DEVICE AND METHOD OF DRIVING THE SAME

(71) Applicant: LG Display Co., Ltd., Seoul (KR)

(72) Inventors: Yong Hyeon SHIN, Paju-si (KR); Hoon Sang RYU, Paju-si (KR); Gun Hee KU, Paju-si (KR)

(73) Assignee: LG Display Co., Ltd., Seoul (KR)

(21) Appl. No.: 19/315,425

(22) Filed: Aug. 29, 2025

(30) Foreign Application Priority Data
Oct. 8, 2024 (KR) 10-2024-0137017

(51) Int. Cl. G09G 3/3233

(52) U.S. Cl. CPC G09G 3/3233; G09G 2300/0819; G09G 2300/0842; G09G 2300/0861; G09G 2310/08; G09G 2320/0233; G09G 2340/0435

(57) ABSTRACT

A display device includes a display panel including a plurality of subpixels each having a light emitting element, a data driver configured to supply a data voltage to each of the subpixels, and a gate driver configured to output a scan signal for driving the light emitting element, wherein each of the plurality of subpixels receives a first anode reset voltage through an anode of the light emitting element during a refresh period in which the data voltage is supplied, and receives a second anode reset voltage through the anode of the light emitting element during a hold period in which the data voltage supplied during the refresh period is maintained.

This application claims the benefit of Korean Patent Application No. 10-2024-0137017, filed on Oct. 8, 2024, which is hereby incorporated by reference as if fully set forth herein.

### BACKGROUND

### Field of the Disclosure

The present disclosure relates to a display device and a method of driving the same.

### Discussion of the Related Art

Among display devices, an electroluminescent display device may display an image by including a plurality of subpixels and causing a light emitting element of each subpixel to emit light. Each of the plurality of subpixels includes a light emitting element and a plurality of transistors for driving the light emitting element, and may display a desired image by controlling the amount of current applied to the light emitting element.

As such a display device continues to operate, a hysteresis phenomenon occurs in which a threshold voltage of a transistor changes, and ripples may occur in an input voltage due to parasitic capacitance or coupling. As a result, as the amount of current for driving the light emitting element changes, a difference in luminance occurs between pixels.

Accordingly, attempts have been made to improve image quality by reducing a luminance deviation between each subpixel.

### SUMMARY

Accordingly, the present disclosure is directed to a display device and a method of driving the same that substantially obviate one or more problems due to limitations and disadvantages of the related art.

Embodiments of the present disclosure provide a display device and a method of driving the same capable of preventing or suppressing image quality degradation that may potentially occur as the display device continues to be driven.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a display device includes a display panel including a plurality of subpixels each having a light emitting element, a data driver configured to supply a data voltage to each of the subpixels, and a gate driver configured to output a scan signal for driving the light emitting element, wherein each of the plurality of subpixels receives a first anode reset voltage through an anode of the light emitting element during a refresh period in which the data voltage is supplied, and receives a second anode reset voltage through the anode of the light emitting element during a hold period in which the data voltage supplied during the refresh period is maintained.

The display device may further include a first anode reset voltage supply unit configured to supply the first anode reset voltage, and a second anode reset voltage supply unit configured to supply the second anode reset voltage.

The first anode reset voltage and the second anode reset voltage may have the same voltage level.

Each of the plurality of subpixels may include a driving transistor configured to generate a driving current of the light emitting element according to the data voltage, a first anode reset switch configured to apply the first anode reset voltage to the anode of the light emitting element in response to a scan signal input during the refresh period, and a second anode reset switch configured to apply the second anode reset voltage to the anode of the light emitting element in response to a scan signal input during the hold period.

The display device may further include a controller configured to control the data driver and the gate driver so that the plurality of subpixels is driven during the refresh period and the hold period.

In another aspect of the present disclosure, a display device includes a display panel including a plurality of subpixels, wherein each of the plurality of subpixels includes a light emitting element including an anode to which driving power is input and a cathode connected to low-potential power, a driving this film transistor (TFT) configured to generate a driving current of the light emitting element, a first anode reset switch configured to apply a first anode reset voltage to the anode of the light emitting element during a refresh period, and a second anode reset switch configured to apply a second anode reset voltage to the anode of the light emitting element during a hold period.

The driving TFT may include a first electrode connected to a first node, a gate electrode connected to a second node, and a second electrode connected to a third node, and each of the plurality of subpixels may further include a first switching TFT configured to interconnect the second node and the third node in response to a first scan signal, a second switching TFT configured to apply a data voltage to the first node in response to a second scan signal, a third switching TFT configured to interconnect a high-potential voltage line and the first node in response to an emission signal, a fourth switching TFT configured to interconnect the third node and the anode of the light emitting element in response to the emission signal, an on-bias TFT configured to apply an on-bias voltage to the first node in response to a third scan signal, and an initialization TFT configured to apply an initialization voltage to the second node in response to a fourth scan signal.

The first anode reset switch may apply the first anode reset voltage in response to a fifth scan signal, and the second anode reset switch may apply the second anode reset voltage in response to a sixth scan signal.

The first anode reset switch may apply the first anode reset voltage in response to a fifth scan signal, and the second anode reset switch may include an eighth switching TFT configured to receive the fifth scan signal together with the first anode reset switch, and be turned on and off opposite to the first anode reset switch, and a ninth switching TFT configured to receive the third scan signal together with the on-bias TFT, and be turned on and off identical to the on-bias TFT.

The first anode reset switch may be a p-type MOSFET (PMOS), and the eighth switching TFT of the second anode reset switch may be an n-type MOSFET (NMOS), and the ninth switching TFT of the second anode reset switch may be a PMOS.

Each of the first switching TFT and the initialization TFT may be an NMOS, and each of the second switching TFT, the third switching TFT, the fourth switching TFT, the second switching TFT, and the on-bias TFT may be a PMOS.

In yet another aspect of the present disclosure, a method of controlling a display device including a plurality of subpixels each having a light emitting element includes performing an operation in a refresh period in which a data voltage is applied to each of the plurality of subpixels, and performing an operation in a hold period in which the data voltage is maintained, wherein the operation in the refresh period includes inputting a first anode reset voltage to an anode of the light emitting element, and the operation in the hold period includes inputting a second anode reset voltage to the anode of the light emitting element.

The first anode reset voltage may be supplied through a first anode reset voltage supply unit, and the second anode reset voltage may be supplied through a second anode reset voltage supply unit.

The first anode reset voltage and the second anode reset voltage may have the same voltage level.

It is to be understood that both the foregoing general description and the following detailed description of the present disclosure are by way of example and explanatory and are intended to provide further explanation of the disclosure as claimed.

### BRIEF DESCRIPTION OF THE DRAWINGS

The accompanying drawings, which are included to provide a further understanding of the present disclosure and are incorporated in and constitute a part of this application, illustrate example embodiment(s) of the present disclosure and together with the description serve to explain principles of the disclosure. In the drawings:

FIG. 1 is a block diagram schematically illustrating a configuration of a display device according to an example embodiment of the present disclosure;

FIG. 2 is a circuit diagram of a subpixel included in a display device according to a first example embodiment of the present disclosure;

FIGS. 3 and 4 are operation waveform diagrams of the subpixel included in the display device according to the first example embodiment of the present disclosure;

FIG. 5 is a drawing for describing the principle of occurrence of unevenness in a center of the display panel;

FIG. 6 and FIG. 7 are operation state diagrams of the subpixel included in the display device according to the first example embodiment of the present disclosure;

FIG. 8 is a circuit diagram of a subpixel included in a display device according to a second example embodiment of the present disclosure;

FIG. 9 and FIG. 10 are diagrams for describing an operation method in a refresh period of the subpixel included in the display device according to the second example embodiment of the present disclosure;

FIG. 11 and FIG. 12 are diagrams for describing an operation method in a hold period of the subpixel included in the display device according to the second example embodiment of the present disclosure; and

FIGS. 13 and 14 are graphs illustrating simulation results of a display device according to a comparative example and the display device according to example embodiments of the present disclosure.

### DETAILED DESCRIPTION

Advantages and features of the present disclosure and a method of achieving the advantages and features will become clear with reference to the example embodiments described in detail below together with the accompanying drawings. However, the present disclosure is not limited to the example embodiments disclosed below and may be implemented in various different forms, and the present embodiments are provided only to make the disclosure of the present disclosure more complete and to more fully inform a person having ordinary skill in the art to which the present disclosure pertain of the scope of the disclosure.

The shapes, sizes, ratios, angles, numbers, etc. disclosed in the drawings to describe the example embodiments of the present disclosure are illustrative, and thus the present disclosure is not limited to the illustrated matters. The same reference numerals refer to the same components throughout the specification. Where the terms “include”, “have”, and “consist of”, etc., are used in the present disclosure, other parts may be added unless a more limiting term like “only” is used. Where a component is expressed in a singular form, this includes the case where the component is plural unless there is a specifically explicit description.

In interpreting a component, the component is to be interpreted as including an error range even if there is no separate explicit description.

Where a positional relationship is described, for example, where a positional relationship between two parts is described as “on”, “above”, “below”, “next to”, etc., one or more other parts may be located between the two parts, unless a more limiting term like “immediately” or “directly”is used.

Even though the terms first, second, etc., may be used to describe various components, these components are not limited by these terms. These terms are only used to refer to one component separately from another. Thus, a first component mentioned below may be a second component, and vice versa, within the technical concept of the present disclosure.

In addition, a pixel circuit and a gate driver of a display device described below may include a plurality of transistors. The transistors may be implemented as an oxide thin film transistor (TFT) including an oxide semiconductor, an LTPS TFT including low temperature poly silicon (LTPS), etc. Each of the transistors may be implemented as a p-channel TFT or an n-channel TFT.

A transistor is a three-electrode device that includes a gate, a source, and a drain. The source is an electrode that supplies carriers to the transistor. Inside the transistor, carriers start to flow from the source. The drain is an electrode through which carriers exit the transistor. In the transistor, carriers flow from the source to the drain. In the case of an n-channel transistor, since the carriers are electrons, a source voltage is lower than a drain voltage so that electrons may flow from the source to the drain. In the n-channel transistor, current flows in a direction from the drain to the source. In the case of a p-channel transistor (PMOS), since the carriers are holes, the source voltage is higher than the drain voltage so that the holes may flow from the source to the drain. In the p-channel transistor, since holes flow from the source to the drain, current flows from the source to the drain. It should be noted that the source and the drain of the transistor are not fixed. For example, the source and the drain may be changed depending on the applied voltage. Therefore, the disclosure is not limited by the source and the drain of the transistor. In the following description, the source and the drain of the transistor will be referred to as first and second electrodes.

A gate signal swings between a gate-on-voltage and a gate-off-voltage. The gate-on-voltage is set to a voltage higher than a threshold voltage of the transistor, and the gate-off-voltage is set to a voltage lower than the threshold voltage of the transistor. The transistor turns on in response to the gate-on-voltage and turns off in response to the gate-off-voltage. In the n-channel transistor, the gate-on-voltage may be a gate-high-voltage (VGH), and the gate-off-voltage may be a gate-low-voltage (VGL). In the p-channel transistor, the gate-on-voltage may be a VGL, and the gate-off-voltage may be a VGH.

Hereinafter, example embodiments of the present disclosure will be described in detail with reference to the attached drawings. Throughout the specification, the same reference numerals refer to substantially the same components. In the following description, where a detailed description of a known function or configuration related to the present disclosure may unnecessarily obscure features or aspects of the present disclosure, the detailed description will be omitted.

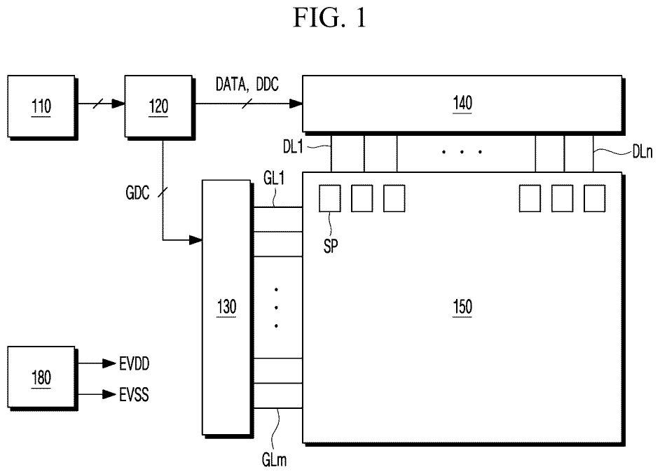

FIG. 1 is a block diagram schematically illustrating a configuration of a display device according to an example embodiment of the present disclosure.

As shown in FIG. 1, the display device may include an image supply unit 110, a timing controller 120, a scan driver 130, a data driver 140, a display panel 150, a power supply 180, etc.

The image supply unit 110 may output various driving signals in addition to an image data signal supplied from the outside or an image data signal stored in an internal memory. The image supply unit 110 may supply data signals and various driving signals to the timing controller 120.

In the display panel 150, a plurality of data lines DL1 to DLn extending in a column direction (or vertical direction) and a plurality of gate lines GL1 to GLm extending in a row direction (or horizontal direction) intersect, and subpixels SPs are arranged in a matrix at each intersection area to form a pixel array. Subpixels SPs arranged in the same pixel line simultaneously operate according to a scan signal and an emission signal EM applied from the same gate line GL. Each subpixel SP includes a light emitting element and a pixel circuit that controls the amount of current applied to an anode of the light emitting element. The pixel circuit may include a driving transistor that controls the amount of current so that a constant current may flow to the light emitting element. The light emitting element emits light during an emission period and does not emit light during periods other than the emission period. Initialization of the pixel circuit, programming, reset of the light emitting element, etc. may be performed during periods other than the emission period.

The timing controller 120 may output a gate timing control signal GDC for controlling the operation timing of the scan driver 130, a data timing control signal DDC for controlling the operation timing of the data driver 140, various synchronization signals (Vsync, which is a vertical synchronization signal, and Hsync, which is a horizontal synchronization signal), etc. The timing controller 120 may supply a data signal DATA supplied from the image supply unit 110 together with the data timing control signal DDC to the data driver 140. The timing controller 120 may be formed as an IC (Integrated Circuit) and mounted on a printed circuit board, but the present disclosure is not limited thereto.

The data driver 140 may sample and latch the data signal DATA in response to the data timing control signal DDC supplied from the timing controller 120, convert a digital data signal into an analog data voltage based on a gamma reference voltage, and output the analog data voltage. The data driver 140 may supply a data voltage to subpixels included in the display panel 150 through data lines DL1 to DLn. The data driver 140 may be formed as an IC and mounted on the display panel 150 or on a printed circuit board, but the present disclosure is not limited thereto.

The scan driver 130 may output a scan signal and an emission signal in response to the gate timing control signal GDC supplied from the timing controller 120. The scan driver 130 may supply at least one scan signal and an emission signal to subpixels included in the display panel 150 through the gate lines GL1 to GLm. The scan driver 130 may be formed as an IC or may be formed directly on the display panel 150 in a gate-in-panel manner.

The power supply 180 may convert power supplied from the outside into power for driving the display device under the control of the timing controller 120 and output the power. For example, the power supply 180 may convert power supplied from the outside into a high-potential voltage EVDD, a low-potential voltage EVSS, etc. and output the voltages, and may generate and output voltages for driving the scan driver 130 (e.g., gate voltages including a gate high voltage and a gate low voltage) or voltages for driving the data driver 140 (drain voltages including a drain voltage and a half drain voltage).

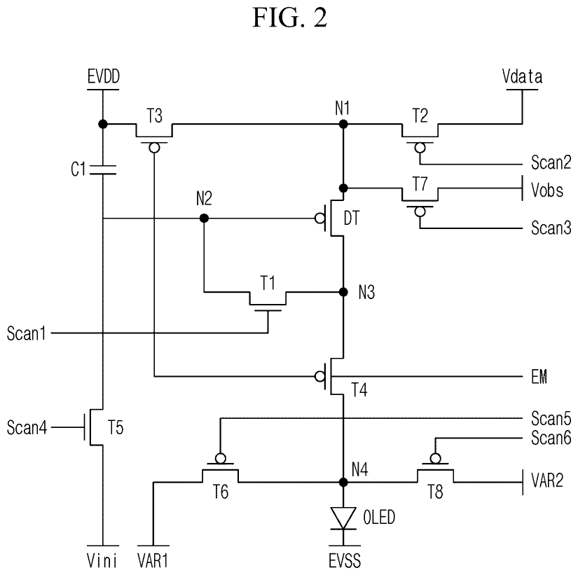

FIG. 2 is a circuit diagram of a subpixel included in a display device according to a first example embodiment of the present disclosure.

As shown in FIG. 2, one subpixel SP may be supplied with the high-potential voltage EVDD, the low-potential voltage EVSS, an initialization voltage Vini, an on-bias stress (OBS) voltage Vobs, a first anode reset voltage VAR1, and a second anode reset voltage VAR2, and may receive first to sixth scan signals Scan1 to Scan6, an emission signal EM, and a data voltage signal Vdata.

One subpixel SP may include an OLED (Organic Light Emitting Diode), a driving TFT DT, a capacitor C1, and first to eighth switching TFTs T1 to T8. Each TFT of the subpixel SP may include a p-type MOSFET (PMOS) or an n-type MOSFET (NMOS). In the present embodiment, a description will be given using an example in which the first switching TFT T1 and the fifth switching TFT T5 are implemented as n-type, and the remaining switching TFTs T2 to T4, and T6 to T9 and the driving TFT DT are implemented as p-type. Accordingly, the first switching TFT T1 and the fifth switching TFT T5 are turned on when a high voltage is applied to a gate electrode, and the remaining switching TFTs T2 to T4, and T6 to T9 and the driving TFT DT are turned on when a low voltage is applied to the gate electrode.

According to the embodiment of the present disclosure, in a subpixel circuit, the first transistor T1 may function as a compensation transistor, the second transistor T2 may function as a data supply transistor, the third and fourth transistors T3 and T4 may function as light emission control transistors, the fifth transistor T5 may function as an initialization transistor, the seventh transistor T7 may function as an on-bias transistor, and sixth and eighth transistors T6 and T8 may function as anode reset transistors.

The OLED emits light by a driving current supplied from the driving TFT DT. An anode of the OLED may be connected to a fourth node N4, and a cathode of the OLED may be connected to a wire to which the low-potential voltage EVSS is provided.

The driving TFT DT may have a gate electrode connected to a second node N2, a first electrode connected to a first node N1, and a second electrode connected to a third node N3. The driving TFT DT may control a driving current supplied to the OLED based on a voltage of the second node N2.

A first capacitor C1 has one electrode connected to the second node N2 to which the gate electrode of the driving TFT DT is connected, and the other electrode connected to the input line of the high-potential voltage EVDD. The first capacitor C1 may store a data voltage for a predetermined period of time and provide the data voltage to the OLED.

The first switching TFT T1 may be turned on in response to a first scan signal Scan1. When the first switching TFT T1 is turned on, the gate electrode and a drain electrode, which is the second electrode, of the driving TFT DT are connected to diode-connect the driving TFT DT. The first switching TFT T1 may include a gate electrode connected to the input line of the first scan signal Scan1, a first electrode connected to the second node N2, and a second electrode connected to the third node N3. The first switching TFT T1 may be an NMOS and may be implemented as an oxide TFT to have a low off-current and minimize or reduce leakage current during a turn-off period. Accordingly, the first switching TFT T1 is turned on in response to the first scan signal Scan1 at a high level, which is a turn-on voltage, and may enable the sampling of the threshold voltage Vth of the driving TFT DT by diode-connecting the second node N2 and the third node N3. This first switching TFT T1 may be a compensation transistor.

The second switching TFT T2 may be turned on in response to the second scan signal Scan2. When the second switching TFT T2 is turned on, the data voltage signal Vdata is applied to the first node N1, which is the first electrode of the driving TFT DT. The second switching TFT T2 may include a gate electrode connected to the input line of the second scan signal Scan2, a first electrode connected to the data line to which the data voltage signal Vdata is supplied, and a second electrode connected to the first node N1. The second switching TFT T2 may apply the data voltage signal Vdata supplied from the data line to the first node N1, which is the first electrode of the driving TFT DT, in response to the second scan signal Scan2 at a low level, which is a turn-on voltage. The second switching TFT T2 may be a data supply transistor.

A control operation is performed to simultaneously turn on/off the third switching TFT T3 and the fourth switching TFT T4 according to the emission signal EM simultaneously input to respective gate electrodes thereof. The third switching TFT T3 and the fourth switching TFT T4 may control whether the OLED emits light. The third switching TFT T3 may have a first electrode connected to the input line of the high-potential voltage EVDD and a second electrode connected to the first node N1. The third switching TFT T3 may serve to transmit the high-potential voltage EVDD to the first electrode of the driving TFT DT in response to the emission signal EM. The fourth switching TFT T4 may have a first electrode connected to the third node N3 and a second electrode connected to the fourth node N4. The fourth switching TFT T4 may serve to transmit a driving current to the anode of the OLED in response to the emission signal EM.

The fifth switching TFT T5 may be turned on in response to the fourth scan signal Scan4. The fifth switching TFT T5 is turned on to apply the initialization voltage Vini to the second node N2, which is the gate electrode of the driving TFT DT. The fifth switching TFT T5 may include a gate electrode connected to the input line of the fourth scan signal Scan4, a first electrode connected to the input line of the initialization voltage Vini, and a second electrode connected to the second node N2. The fifth switching TFT T5 may initialize the gate electrode of the driving TFT DT by applying the initialization voltage Vini to the second node N2, which is the gate electrode of the driving TFT DT, in response to the fourth scan signal Scan4 at a high level, which is a turn-on voltage.

The seventh switching TFT T7 may be turned on in response to the third scan signal Scan3. The seventh switching TFT T7 is turned on to apply an OBS voltage Vobs to the first electrode of the driving TFT DT. The seventh switching TFT T7 may include a gate electrode connected to the input line of the third scan signal Scan3, a first electrode connected to the input line of the OBS voltage Vobs, and a second electrode connected to the first node N1. The seventh switching TFT T7 may apply the OBS voltage Vobs to the first electrode of the driving TFT DT in response to the third scan signal Scan3 at a low level, which is a turn-on voltage. The sixth switching TFT T6 may be turned on in response to the fifth scan signal Scan5.

The sixth switching TFT T6 is turned on to apply the first anode reset voltage VAR1 to the anode of the OLED. The sixth switching TFT T6 may include a gate electrode connected to the input line of the fifth scan signal Scan5, a first electrode connected to the input line of the first anode reset voltage VAR1, and a second electrode connected to the fourth node N4.The sixth switching TFT T6 may apply the first anode reset voltage VAR1 to the anode of the OLED in response to the fifth scan signal Scan5 at a low level, which is a turn-on voltage.

The eighth switching TFT T6 may be turned on in response to the sixth scan signal Scan6. The eighth switching TFT T8 is turned on to apply the second anode reset voltage VAR2 to the anode of the OLED. The eighth switching TFT T8 may include a gate electrode connected to the input line of the sixth scan signal Scan6, a first electrode connected to the input line of the second anode reset voltage VAR2, and a second electrode connected to the fourth node N4. The eighth switching TFT T8 may apply the second anode reset voltage VAR2 to the anode of the OLED in response to the sixth scan signal Scan6 at a low level, which is a turn-on voltage. The second anode reset voltage VAR2 may be a voltage of the same voltage level as that of the first anode reset voltage VAR1.

As described above, the display device according to the first embodiment of the present disclosure may connect the first anode reset voltage VAR1 and the second anode reset voltage VAR2 at the same voltage level to one subpixel using different switching TFTs T6 and T8. Accordingly, when a ripple occurs in one anode reset voltage, the anode of the OLED may be initialized by applying the other anode reset voltage.

The OLED may have a parasitic capacitor formed between the anode and the cathode. In addition, while the OLED emits light, the parasitic capacitor is charged so that the anode may be of a specific voltage. Accordingly, the quantity of electric charge accumulated in the OLED may be initialized by applying the first anode reset voltage VAR1 to the anode of the OLED through the sixth switching TFT T6. Meanwhile, an anode reset operation may be sequentially performed in units of subpixels connected to the same gate line. That is, the anode reset may be sequentially performed in units of horizontal pixel lines, and a ripple may occur in the first anode reset voltage VAR1 due to coupling of scan signals, etc. depending on the operation of each pixel line. When a ripple occurs in the first anode reset voltage VAR1, the parasitic capacitor charged in the OLED is not sufficiently discharged, causing an anode voltage to increase. Accordingly, the anode of the OLED may be initialized by applying the second anode reset voltage VAR2 supplied independently from the first anode reset voltage VAR1 to the anode of the OLED.

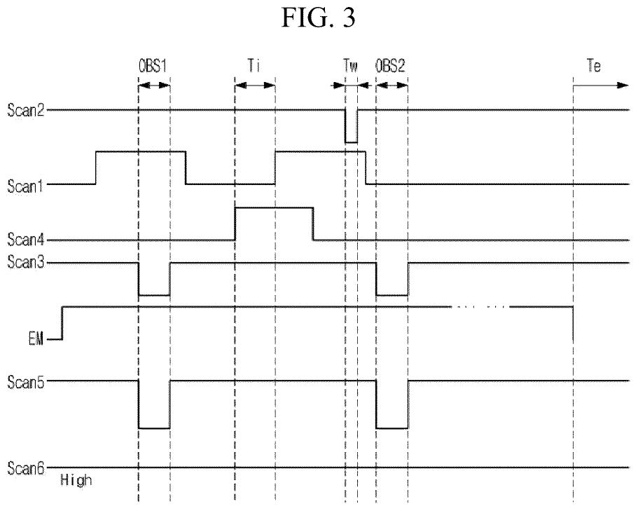

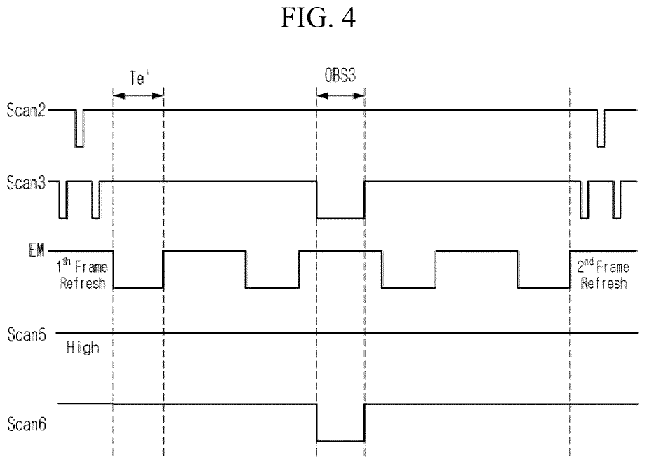

FIGS. 3 and 4 are operation waveform diagrams of the subpixel included in the display device according to the first example embodiment of the present disclosure.

The display device according to the embodiment of the present disclosure may operate as a VRR (variable refresh rate) mode display device. In the VRR mode, operation may be performed at a constant frequency, a refresh rate at which a data voltage Vdata is updated may be increased when high-speed operation is to be performed, and the refresh rate may be lowered to operate the subpixel when power consumption is reduced or low-speed operation is to be performed.

When the subpixel operates at the lowered refresh rate, operation may be performed using a combination of a refresh frame and a hold frame within 1 second. For example, in a display device operated at 120 Hz, when operation is performed at a refresh rate of 120 Hz, operation may be performed only in the refresh period. That is, the refresh period may be performed 120 times per second, so that 120 image screens may be reproduced for 1/120 sec each. When operation is performed at a refresh rate lower than 120 Hz, the operation may be performed by combining the refresh period and the hold period. During the refresh period, a data voltage may be supplied to the subpixel SP, and during the hold period, the data voltage input during the refresh period may be held. When the refresh rate is 60 Hz, the refresh period and the hold period may be alternately performed 60 times each within 1 second. When operation is performed at the refresh rate of 60 Hz, the refresh period is performed 60 times per second, so that 60 image screens may be reproduced for 2/120 sec each. When operation is performed at a refresh rate of 1 Hz, the operation may be performed in one refresh period and 119 hold periods. When operation is performed at the refresh rate of 1 Hz, the refresh period may be performed once per second, so that one image screen may be reproduced.

FIG. 3 is a diagram illustrating scan signals and an emission control signal of the refresh period, and FIG. 4 is a diagram illustrating scan signals and an emission control signal of a hold period.

As shown in the waveform diagram of FIG. 3 and the subpixel circuit diagram of FIG. 2, the refresh period may include an initialization period Ti, a data writing period Tw, and an emission period Te, and may further include at least one bias period OBS1 and OBS2. The initialization period Ti and the data writing period Tw may be performed during a non-emission period in which the emission signal EM is applied at the off level. In this non-emission period, a plurality of OBS operations may be performed.

During an OBS operation, the hysteresis of the driving transistor DT may be alleviated by supplying a bias voltage Vobs to the first node N1 to which a source electrode of the driving transistor DT is connected. In addition, the anode may be initialized by applying a reset voltage to the fourth node N4 to which the anode of the OLED is connected. The display device according to the embodiment of the present disclosure may initialize the anode of the OLED by applying the first anode reset voltage VAR1 or the second anode reset voltage VAR2 that is independently supplied in the refresh period and the hold period, respectively. In the present embodiment, a description will be given of the case where the anode of the OLED is initialized by applying the first anode reset voltage VAR1 during the refresh period and applying the second anode reset voltage VAR2 during the hold period.

During the first bias period OBS1, the first scan signal Scan1, the third scan signal Scan3, and the fifth scan signal Scan5 are applied at the on level. In response to the first scan signal Scan1 being applied at a high voltage, which is the on level, the first switching TFT T1 may be turned on to interconnect the gate electrode and the drain electrode, which is the second electrode, of the driving TFT DT. In response to the third scan signal Scan3 being applied at a low voltage, which is the on level, the seventh switching TFT T7 may be turned on to apply the bias voltage Vobs to the first electrode of the driving TFT DT. In response to the fifth scan signal Scan5 being applied at a low voltage, which is the on level, the sixth switching TFT T6 may be turned on to apply the first anode reset voltage VAR1 to the anode of the OLED.

During the initial period Ti, the fourth scan signal Scan4 is applied at the on level. In response to the fourth scan signal Scan4 being applied at a high voltage, which is the on level, the fifth switching TFT T5 is turned on to apply the initialization voltage Vini to the second node N2, which is the gate electrode of the driving TFT DT. Accordingly, the gate electrode of the driving TFT DT may be initialized with the initialization voltage Vini.

The data writing period Tw is a period in which the threshold voltage Vth of the driving TFT DT is sampled and the data voltage Vdata is programmed. During the data writing period Tw, the first scan signal Scan1 and the second scan signal Scan2 are applied at the on level. In response to the first scan signal Scan1 being applied at a high voltage, which is the on level, the first switching TFT T1 is turned on, so that the driving TFT DT may be diode-connected. In response to the second scan signal Scan2 being applied at a low voltage, which is the on level, the second switching TFT T2 is turned on, so that the data voltage signal Vdata is applied to the first node N1, which is the first electrode of the driving TFT DT. During the data writing period Tw, the driving TFT DT is turned on, so that a current Ids flows between the source and the drain. Since the gate electrode and the drain electrode of the driving TFT DT are diode-connected, the voltage of the third node N3 increases due to a current flowing from the source electrode to the drain electrode until the gate-source voltage Vgs of the driving TFT DT reaches the threshold voltage Vth. Accordingly, the third node N3 is charged with a voltage Vdata-|Vth|corresponding to a difference between the data voltage Vdata and the threshold voltage Vth of the driving TFT DT. When the data writing period Tw is completed, the data voltage Vdata may be stored in the first capacitor C1 together with a compensation voltage of the threshold voltage Vth.

During the second OBS period OBS2, the third scan signal Scan3 and the fifth scan signal Scan5 are applied at the on level. In response to the third scan signal Scan3 being applied at a low voltage, which is the on level, the seventh switching TFT T7 is turned on, so that the bias voltage Vobs may be applied to the first electrode of the driving TFT DT. In response to the fifth scan signal Scan5 being applied at a low voltage, which is the on level, the sixth switching TFT T6 is turned on, so that the first anode reset voltage VAR1 may be applied to the anode of the OLED.

During the emission period Te, the emission signal EM is applied at the on level. In response to the emission signal EM being applied at a low voltage, which is the on level, the third switching TFT T3 and the fourth switching TFT T4 are simultaneously turned on. When the third switching TFT T3 and the fourth switching TFT T4 are turned on, the first electrode of the driving TFT DT may be connected to the input line of the high-potential voltage EVDD, and the second electrode may be connected to the anode of the OLED. Accordingly, a driving current is applied to the OLED, and the OLED may be made to emit light with a driving current corresponding to the data voltage.

As described above, the display device according to the embodiment of the present disclosure may write the data voltage Vdata and perform a plurality of OBS operations in the non-emission period of the refresh period. When an OBS operation is performed in the refresh period, the first anode reset voltage VAR1 is applied to the anode of the OLED, and the second anode reset voltage VAR2 is not applied thereto. Therefore, during the refresh period, to control the sixth switching TFT T6 that applies the first anode reset voltage VAR1, the fifth scan signal Scan5 is applied at the on level during an OBS operation period. Since the eighth switching TFT T8 that applies the second anode reset voltage VAR2 needs to be maintained in the off state, the sixth scan signal Scan6 is maintained at the off level during the refresh period.

As shown in the waveform diagram of FIG. 4 and the subpixel circuit diagram of FIG. 2, the hold period may include at least one bias period OBS3 and an emission period Te'.

As described above, charging with the data voltage Vdata is performed during the refresh period, while the data voltage Vdata of the refresh period is maintained without change and used during the hold period. Accordingly, the hold period includes only the bias period OBS3 and the emission period Te', and does not include the initialization period Ti and the data writing period Tw. Since the initialization and data writing operation is not performed, the first scan signal Scan1, the second scan signal Scan2, and the fourth scan signal Scan4 for initialization and sampling control are maintained at an off-level voltage.

During the hold period, the emission signal EM may be PWM controlled to improve image quality. Accordingly, the emission signal EM is supplied as a pulse signal, and the third switching TFT T3 and the fourth switching TFT T4 may be turned on/off according to the on level and the off level of the emission signal EM.

During the hold period, it may be sufficient to perform the OBS operation once. However, the OBS operation may be performed twice or more. In the present embodiment, the case where the OBS operation is performed once during the hold period is given as an example.

In the hold period, the third scan signal Scan3 and the sixth scan signal Scan6 are applied at the on level during the OBS period OBS3. In response to the third scan signal Scan3 being applied at a low voltage, which is the on level, the seventh switching TFT T7 is turned on, so that the bias voltage Vobs may be applied to the first electrode of the driving TFT DT. In response to the sixth scan signal Scan6 being applied at a low voltage, which is the on level, the eighth switching TFT T8 is turned on, so that the second anode reset voltage VAR2 may be applied to the anode of the OLED. The second anode reset voltage VAR2 may have the same voltage level as that of the first anode reset voltage VAR1 and may be a voltage supplied from a separate source from the first anode reset voltage VAR1.

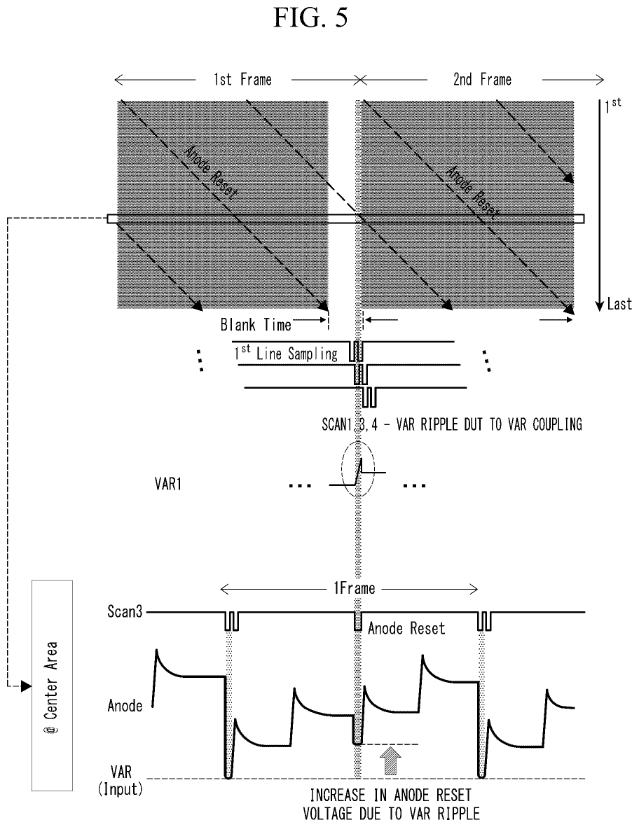

FIG. 5 is a drawing for describing the principle of occurrence of unevenness in a center of a display panel when displaying an image in a display device according to a comparative example. The display device according to the comparative example may display an image by performing a refresh operation and a hold operation, and may perform an anode reset operation under the control of the third scan signal Scan3 during the hold operation. FIG. 5 illustrates an anode reset order on the display panel, an operation waveform of the third scan signal Scan3 for each pixel line, a waveform of the first anode reset voltage VAR1, and a voltage state of the anode of the OLED.

As shown in FIG. 5, when an image is displayed on the display panel, the pixel array may be sequentially operated in units of horizontal lines. A 1-frame period may include a display period in which the image is displayed and a blank period Blank Time. Here, the period in which the image is displayed may include a refresh period and a hold period. Accordingly, when the image is displayed, the refresh operation is performed and then the hold operation is performed sequentially from a first line 1st Line. During the hold operation, anode reset may be performed by a third scan signal. The anode reset operation may be sequentially performed from the first line 1st Line.

When the display panel is operated in this order, in response to start of a refresh section of a second frame 2nd Frame and start of sequential data writing (sampling) from the first line 1st Line, pixels in a center area (@Center area) of the panel perform an anode reset operation. Accordingly, coupling may occur in the anode reset voltage VAR due to scan signals Scan 1, 3, and 4 input at a high voltage level for the refresh operation from the first line 1st Line, which may cause VAR ripples that increase the anode reset voltage VAR. When the anode reset operation is performed in a state where the anode reset voltage VAR has increased, the anode of the OLED may not be sufficiently discharged, and thus luminance of the corresponding pixels may increase. As a result, when the refresh section of the second frame 2nd Frame starts, luminance of the pixels in the center area (@Center area) of the panel may increase, causing unevenness. Accordingly, the embodiment of the present disclosure resets the anode to the first anode reset voltage VAR1 during the refresh period and performs the anode reset operation using the second anode reset voltage VAR2 during the hold period, thereby preventing or suppressing the ripple of the first anode reset voltage VAR1 generated during the refresh period from affecting the anode reset during the hold period.

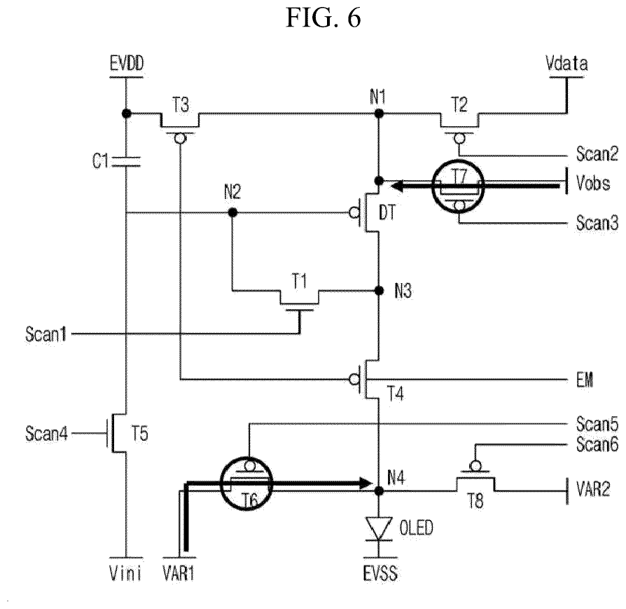

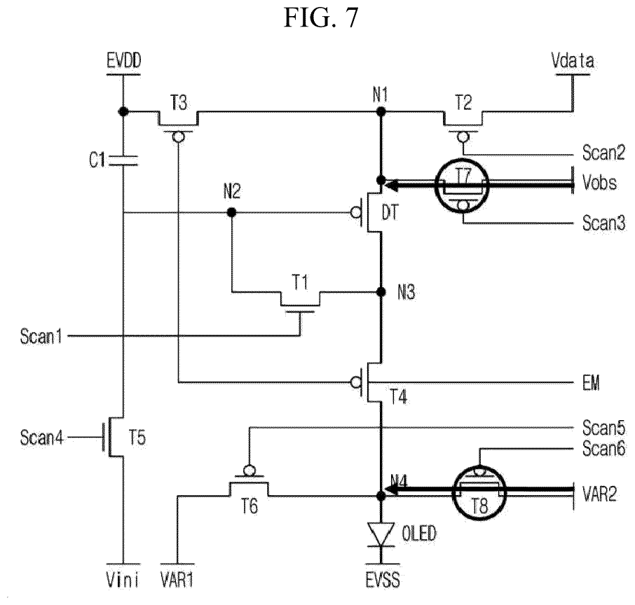

FIG. 6 and FIG. 7 are operation state diagrams of the subpixel included in the display device according to the first example embodiment of the present disclosure.

FIG. 6 is a diagram illustrating an OBS operation state of the subpixel in the bias periods OBS1 and OBS2 of the refresh period. As shown in FIG. 6, the third scan signal Scan3 and the fifth scan signal Scan5 are applied at the on level during the bias periods OBS1 and OBS2 of the refresh period. In response to the third scan signal Scan3 being applied at a low voltage, which is the on level, the seventh switching TFT T7 is turned on, so that the bias voltage Vobs may be applied to the first electrode of the driving TFT DT. In response to the fifth scan signal Scan5 being applied at a low voltage, which is the on level, the sixth switching TFT T6 is turned on, so that the first anode reset voltage VAR1 may be applied to the anode of the OLED.

FIG. 7 is a diagram illustrating an OBS driving state of the subpixel in the bias period OBS3 of the hold period. As shown in FIG. 7, during the bias period OBS3 of the hold period, the third scan signal Scan3 and the sixth scan signal Scan6 are applied at on levels. In response to the third scan signal Scan3 being applied at a low voltage, which is the on level, the seventh switching TFT T7 is turned on, so that the bias voltage Vobs may be to the first electrode of the driving TFT DT. In response to the sixth scan signal Scan6 being applied at a low voltage, which is the on level, the eighth switching TFT T8 is turned on, so that the second anode reset voltage VAR2 may be applied to the anode of the OLED.

As described above, the subpixel included in the display device according to the first embodiment of the present disclosure includes the sixth switching TFT T6 turned on by the fifth scan signal Scan5 during the refresh period to apply the first anode reset voltage VAR1 to the anode of the OLED, and the eighth switching TFT T8 turned on by the sixth scan signal Scan6 during the hold period to apply the second anode reset voltage VAR2 to the anode of the OLED, so that the anode of the OLED may be initialized to the anode reset voltages VAR1 and VAR2 independently supplied during the refresh period and the hold period, respectively.

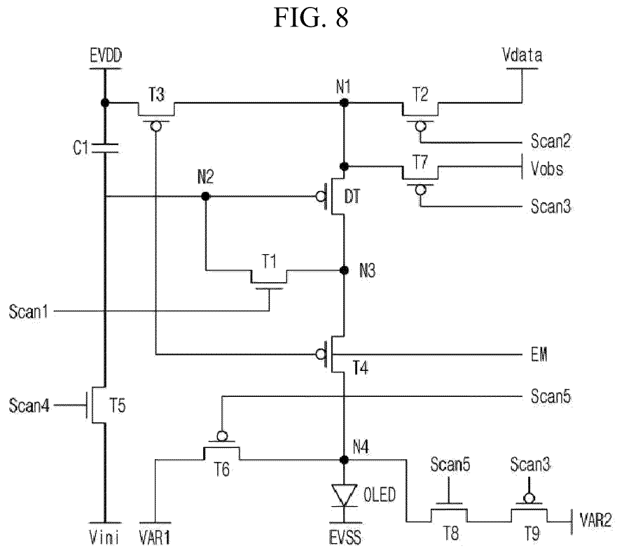

FIG. 8 is a circuit diagram of a subpixel included in a display device according to a second example embodiment of the present disclosure.

When compared to the subpixel of FIG. 8 with the subpixel of the first example embodiment of FIG. 2, there is a difference in a circuit configuration for applying the second anode reset voltage VAR2 to the anode of the OLED.

The subpixel of FIG. 2 may apply the second anode reset voltage VAR2 to the anode of the OLED by turning on the eighth switching TFT T8 using the sixth scan signal Scan6. Here, the sixth scan signal Scan6 is a scan signal added for on-off control of the eighth switching TFT T8. Therefore, the eighth switching TFT T8 may be implemented as either an N type or a P type, and the sixth scan signal Scan6 may be applied to turn on the eighth switching TFT T8 during the hold period.

In comparison, the subpixel of FIG. 8 may control a second anode reset voltage VAR2 using two TFTs T8 and T9 while using scan signals Scan3 and Scan5 for driving the existing subpixel without adding a separate scan signal.

As shown in FIG. 8, the subpixel according to the second embodiment of the present disclosure may be supplied with a high-potential voltage EVDD, a low-potential voltage EVSS, an initialization voltage Vini, an OBS voltage Vobs, a first anode reset voltage VAR1, and a second anode reset voltage VAR2, and may receive first to fifth scan signals Scan1 to Scan5, an emission signal EM, and a data voltage signal Vdata.

The subpixel may include an OLED, a driving TFT DT, a capacitor C1, and first to ninth switching TFTs T1 to T9. Here, the remaining components except for the eighth switching TFT T8 and the ninth switching TFT T9 operate in the same manner as the subpixel of FIG. 2, and thus a detailed description thereof will be omitted.

The eighth switching TFT T8 and the ninth switching TFT T9 are interposed in a power line connecting the second anode reset voltage VAR2 and the anode of the OLED, and may control whether the second anode reset voltage VAR2 is applied. The eighth switching TFT T8 and the ninth switching TFT T9 are connected in series, and when both the switching TFTs T8 and T9 are turned on, the second anode reset voltage VAR2 may be applied to the anode of the OLED.

The eighth switching TFT T8 may be turned on in response to the fifth scan signal Scan5. The eighth switching TFT T8 may include a gate electrode connected to the input line of the fifth scan signal Scan5, a first electrode connected to the ninth switching TFT T9 that applies the second anode reset voltage VAR2, and a second electrode connected to the fourth node N4. The fifth scan signal Scan5 that controls on/off of the eighth switching TFT T8 is simultaneously input to the sixth switching TFT T6 that applies the first anode reset voltage VAR1. The sixth switching TFT T6 and the eighth switching TFT T8 are implemented as different types of TFTs so that when the same scan signal is input, one of the two TFTs is turned on and the other is turned off. The embodiment of the present disclosure illustrates the case where the sixth switching TFT T6 is a p-type MOSFET (PMOS) and the eighth switching TFT T8 is an NMOS. Therefore, when the sixth switching TFT T6 is turned on by the fifth scan signal Scan5, the eighth switching TFT T8 may be turned off, and when the eighth switching TFT T8 is turned on, the sixth switching TFT T6 may be turned off. Accordingly, when the sixth switching TFT T6 is turned on and the first anode reset voltage VAR1 is applied to the anode of the OLED, the second anode reset voltage VAR2 may be blocked by the eighth switching TFT T8. When the eighth switching TFT T8 is turned on and the second anode reset voltage VAR2 is applied, the first anode reset voltage VAR1 may be blocked by the sixth switching TFT T6.

The ninth switching TFT T9 may be turned on in response to the third scan signal Scan3. The ninth switching TFT T9 may include a gate electrode connected to the input line of the third scan signal Scan3, a first electrode connected to the input line of the second anode reset voltage VAR2, and a second electrode connected to the eighth switching TFT T8. The third scan signal Scan3 for controlling on/off of the ninth switching TFT T9 is a signal for controlling an OBS operation, and is simultaneously input to the seventh switching TFT T7 for applying the OBS voltage Vobs to the first electrode of the driving TFT DT. The ninth switching TFT T9 is implemented as a TFT of the same type as that of the seventh switching TFT T7, and may be turned on in a bias period OBS in which the third scan signal Scan3 is input. The embodiment of present disclosure illustrates an example in which each of the seventh switching TFT T7 and the ninth switching TFT T9 is a PMOS. Accordingly, when the third scan signal Scan3 at a low voltage level is input, the ninth switching TFT T9 is turned on, so that the second anode reset voltage VAR2 may be applied to the first electrode of the eighth switching TFT T8.

According to this configuration, when the ninth switching TFT T9 is turned on to apply the second anode reset voltage VAR2 to the first electrode of the eighth switching TFT T8, and the eighth switching TFT T8 is turned on by the fifth scan signal Scan5, the second anode reset voltage VAR2 may be applied to the anode of the OLED.

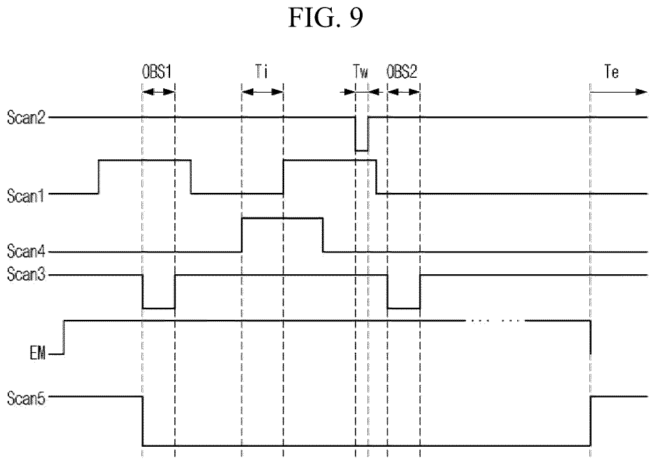

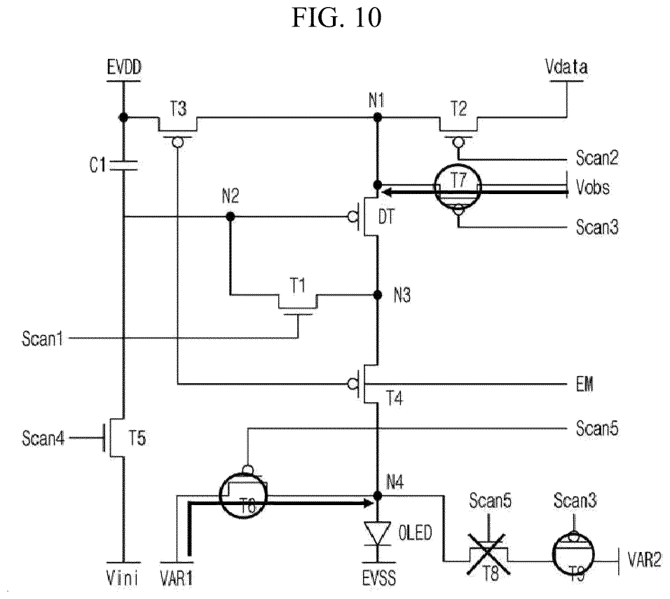

FIG. 9 and FIG. 10 are diagrams for describing an operation method in a refresh period of the subpixel included in the display device according to the second example embodiment of the present disclosure. FIG. 9 is a diagram illustrating an operation waveform in the refresh period, and FIG. 10 is a diagram illustrating an OBS operation state of the subpixel in the bias periods OBS1 and OBS2 of the refresh period. The refresh period includes an initialization period Ti, a data writing period Tw, and an emission period Te, and may include at least one bias period OBS1 and OBS2.

When the operation waveform diagram in the refresh period of the subpixel according to the second embodiment of FIG. 9 is compared with the operation waveform diagram in the refresh period of the subpixel according to the first embodiment of FIG. 3, only a waveform of the fifth scan signal Scan5 is different, and waveforms of the first to fourth scan signals Scan1 to Scan4 and the emission signal EM are the same.

In the subpixel according to the first embodiment, the fifth scan signal Scan5 is applied as a low voltage, which is the on level, only during the bias periods OBS1 and OBS2. Accordingly, the sixth switching TFT T6 is turned on during the bias periods OBS1 and OBS2, so that the first anode reset voltage VAR1 may be applied to the anode of the OLED.

On the other hand, in the subpixel according to the second embodiment, the fifth scan signal Scan5 is applied at the low level during the first bias period OBS1, and then is maintained in a low voltage state until the emission period Te starts.

In the refresh period of the subpixel according to the second embodiment, an operation method in the initialization period Ti, the data writing period Tw, and the emission period Te is the same as that of the subpixel according to the first embodiment, and thus a detailed description thereof is omitted. An OBS operation method in the refresh period of the subpixel according to the second embodiment will be described in detail with reference to FIG. 10.

As shown in FIGS. 9 and 10, the third scan signal Scan3 and the fifth scan signal Scan5 are applied at low voltages during the bias periods OBS1 and OBS2 of the refresh period.

In response to the third scan signal Scan3 being applied at the low voltage, the seventh switching TFT T7 is turned on, so that the bias voltage Vobs may be applied to the first electrode of the driving TFT DT.

In response to the fifth scan signal Scan5 being applied at a low voltage, the sixth switching TFT T6 is turned on, so that the first anode reset voltage VAR1 may be applied to the anode of the OLED. Accordingly, after the first bias period OBS1 starts, the anode of the OLED may maintain a state of the first anode reset voltage VAR1 until the emission period Te starts.

Meanwhile, in response to the third scan signal Scan3 being applied at a low voltage, the ninth switching TFT T9 is turned on to apply the second anode reset voltage VAR2 to the first electrode of the eighth switching TFT T8. However, in response to the fifth scan signal Scan5 being applied at a low voltage, the eighth switching TFT T8 may be maintained in an off state. Accordingly, even when the ninth switching TFT T9 is turned on in response to the third scan signal Scan3 during the bias periods OBS1 and OBS2, the second anode reset voltage VAR2 may be blocked since the eighth switching TFT T8 is in an off state.

As described above, the display device according to the second embodiment of the present disclosure may be initialized by applying the first anode reset voltage VAR1 to the anode of the OLED during the bias periods OBS1 and OBS2 of the refresh period.

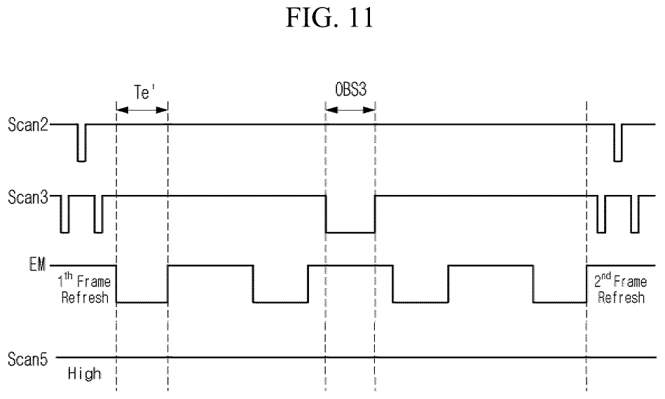

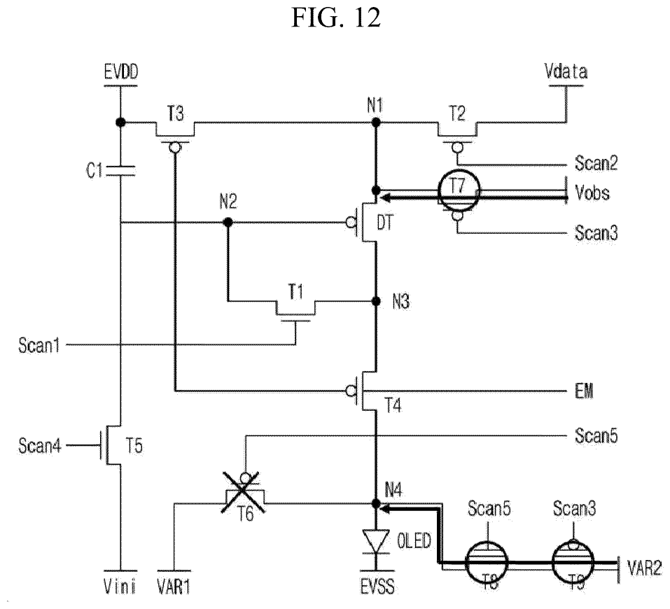

FIG. 11 and FIG. 12 are diagrams for describing an operation method in the hold period of the subpixel included in the display device according to the second example embodiment of the present disclosure. FIG. 11 is a diagram illustrating an operation waveform in the hold period, and FIG. 12 is a diagram illustrating an OBS operation state of the subpixel in the bias period OBS3 of the hold period. The hold period includes only the bias period OBS3 and the emission period Te′, and does not include the initialization period Ti and the data writing period Tw.

The operation waveform diagram in the hold period of the subpixel according to the second embodiment of FIG. 11 is the same as the operation waveform diagram in the hold period of the subpixel according to the first embodiment of FIG. 4. That is, the first scan signal Scan1, the second scan signal Scan2, and the fourth scan signal Scan4 for initialization and sampling control are maintained at off-level voltages. The fifth scan signal Scan5 for applying the first anode reset voltage VAR1 is applied at a high voltage so that the sixth switching TFT T6 applying the first anode reset voltage VAR1 is turned off. The emission signal EM may be PWM-controlled and supplied as a pulse signal.

As shown in FIGS. 11 and 12, during the bias period OBS3 of the hold period of the subpixel according to the second embodiment, the third scan signal Scan3 may be applied at a low voltage, and the fifth scan signal Scan5 may be applied at a high voltage.

In response to the third scan signal Scan3 being applied at a low voltage, the seventh switching TFT T7 is turned on, so that the bias voltage Vobs may be applied to the first electrode of the driving TFT DT.

In addition, in response to the third scan signal Scan3 being applied at a low voltage, the ninth switching TFT T9 may be turned on. In response to the ninth switching TFT T9 being turned on, the second anode reset voltage VAR2 may be applied to the first electrode of the eighth switching TFT T8.

In response to the fifth scan signal Scan5 being applied at a high voltage, the sixth switching TFT T6 is turned off. In response to the sixth switching TFT T6 being turned off, the first anode reset voltage VAR1 may be blocked from being applied to the anode of the OLED.

Meanwhile, in response to the fifth scan signal Scan5 being applied at a high voltage, the eighth switching TFT T8 is turned on. Accordingly, both the eighth switching TFT T8 and the ninth switching TFT T9 are turned on. In response to the eighth switching TFT T8 being turned on, the second anode reset voltage VAR2 transmitted through the ninth switching TFT T9 may be applied to the anode of the OLED.

As described above, the display device according to the second embodiment of the present disclosure may be initialized by applying the second anode reset voltage VAR2 to the anode of the OLED during the bias period OBS3 of the hold period.

The subpixel included in the display device according to the second embodiment of the present disclosure includes the ninth switching TFT T9 turned on by the third scan signal Scan3 to apply the second anode reset voltage VAR2, and the eighth switching TFT T8 turned off by the fifth scan signal Scan5 in the refresh period and turned on by the fifth scan signal Scan5 in the hold period to apply the second anode reset voltage VAR2 applied from the ninth switching TFT T9 to the anode of the OLED, so that the anode of the OLED may be initialized to the anode reset voltages VAR1 and VAR2 independently supplied in the refresh period and the hold period, respectively. The second embodiment of the present disclosure may control the second anode reset voltage VAR2 by adding the two TFTs T8 and T9 while using the existing scan signals Scan3 and Scan5 for driving subpixels without adding a separate scan signal. Therefore, the coupling of the parasitic capacitance due to the scan line may be reduced, thereby minimizing or reducing occurrence of ripples in the anode reset voltage.

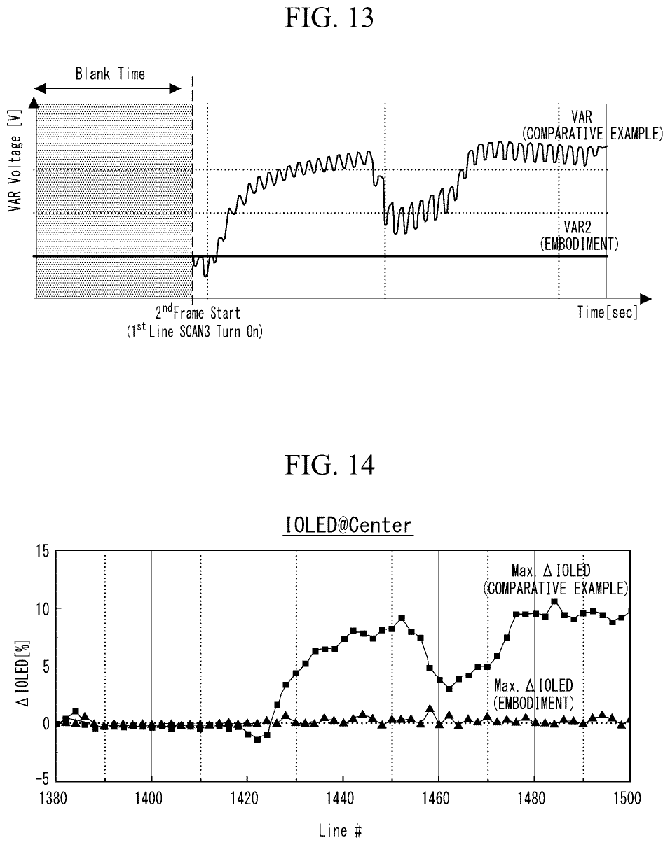

FIGS. 13 and 14 are graphs illustrating simulation results of a display device according to a comparative example and the display device according to example embodiments of the present disclosure.

FIG. 13 is a graph illustrating a simulation result of an anode voltage of subpixels in a center area of a panel when the refresh section of the second frame 2nd Frame starts and the pixels in the center area of the panel perform an anode reset operation.

After a blank time of the first frame 1st Frame ends and then a refresh period of the second frame 2nd Frame starts, data writing (sampling) starts sequentially from a first line 1st Line. In this instance, pixels in a center line of the panel perform the anode reset operation. By measuring an anode voltage of the subpixels in which anode reset is performed, the magnitude of the anode reset voltage VAR may be determined. As a result of the simulation, as shown in the graph of FIG. 13, it is possible to confirm that the anode reset voltage VAR of the display device according to the comparative example generates ripples, whereas the anode reset voltage VAR2 of the display device according to the embodiment maintains a constant voltage.

FIG. 14 is a simulation result of change β in pixel current in the center area of the panel under the same condition as that of FIG. 13.

When an anode reset operation is performed in a state in which a ripple occurs in the anode reset voltage VAR, the anode of the OLED is not sufficiently discharged, and thus a value IOLED of current flowing to the OLED may increase.

As a result of the simulation, as shown in the graph of FIG. 14, it is possible to confirm that the change ΔIOLED in pixel current of the display device according to the comparative example increases similarly to the increase in ripples of the anode reset voltage VAR of FIG. 13. On the other hand, it is possible to confirm that the display device according to the embodiment has the reduced change ΔIOLED in pixel current due to the ripples, and thus relatively stably maintains the change ΔIOLED in pixel current.

The display device according to the embodiment of the present disclosure supplies the anode reset voltage input during the refresh period and the anode reset voltage input during the hold period independently of each other, thereby preventing or suppressing the ripples of the anode reset voltage generated during the refresh period from affecting the hold period. In this way, it is possible to prevent the image quality from deteriorating during the hold period.

The embodiments of the present disclosure have the following effects.

The embodiments of the present disclosure provide a display device and a method of driving the same capable of preventing or suppressing deterioration in image quality due to luminance deviation between subpixels during a hold period when the display device is driven at a low speed.

The embodiments of the present disclosure supply an anode reset voltage input during a refresh period and an anode reset voltage input during a hold period independently of each other, thereby preventing or suppressing ripples of the anode reset voltage generated during the refresh period from affecting the hold period. In this way, it is possible to prevent luminance of a screen from fluctuating during the hold period.

The effects of the present disclosure are not limited to those illustrated above, and various additional effects are included within, or may be learned from the practice of, the present disclosure.

Even though the example embodiments of the present disclosure have been described in more detail with reference to the attached drawings, the present disclosure is not necessarily limited to these example embodiments, and various modifications may be made without departing from the technical spirit of the present disclosure. Accordingly, the example embodiments disclosed in the present disclosure are not intended to limit the technical spirit of the present disclosure but to describe the technical spirit, and the scope of the technical spirit of the present disclosure is not limited by these embodiments. Therefore, it should be understood that the embodiments described above are illustrative and not restrictive in all respects. The scope of protection of the present disclosure may be interpreted based on the claims and their equivalents, and all technical ideas within a scope equivalent thereto should be interpreted as being included in the scope of rights of the present disclosure.

What is claimed IS:

1. A display device, comprising:
a display panel including a plurality of subpixels each having a light emitting element;
a data driver configured to supply a data voltage to each of the subpixels; and
a gate driver configured to output a scan signal for driving the light emitting element,
wherein each of the plurality of subpixels receives a first anode reset voltage through an anode of the light emitting element during a refresh period in which the data voltage is supplied, and receives a second anode reset voltage through the anode of the light emitting element during a hold period in which the data voltage supplied during the refresh period is maintained.

2. The display device according to claim 1, further comprising:
a first anode reset voltage supply unit configured to supply the first anode reset voltage; and
a second anode reset voltage supply unit configured to supply the second anode reset voltage.

3. The display device according to claim 1, wherein the first anode reset voltage and the second anode reset voltage have the same voltage level.

4. The display device according to claim 1, wherein each of the plurality of subpixels comprises:
a driving transistor configured to generate a driving current of the light emitting element according to the data voltage;
a first anode reset switch configured to apply the first anode reset voltage to the anode of the light emitting element in response to a scan signal input during the refresh period; and
a second anode reset switch configured to apply the second anode reset voltage to the anode of the light emitting element in response to a scan signal input during the hold period.

5. The display device according to claim 1, further comprising a controller configured to control the data driver and the gate driver so that the plurality of subpixels is driven during the refresh period and the hold period.

6. A display device, comprising:
a display panel comprising a plurality of subpixels,
wherein each of the plurality of subpixels comprises:
a light emitting element comprising an anode to which driving power is input and a cathode connected to low-potential power;
a driving this film transistor (TFT) configured to generate a driving current of the light emitting element;
a first anode reset switch configured to apply a first anode reset voltage to the anode of the light emitting element during a refresh period; and
a second anode reset switch configured to apply a second anode reset voltage to the anode of the light emitting element during a hold period.

7. The display device according to claim 6, wherein:
the driving TFT comprises a first electrode connected to a first node, a gate electrode connected to a second node, and a second electrode connected to a third node, and
each of the plurality of subpixels further comprises:
a first switching TFT configured to interconnect the second node and the third node in response to a first scan signal;
a second switching TFT configured to apply a data voltage to the first node in response to a second scan signal;
a third switching TFT configured to interconnect a high-potential voltage line and the first node in response to an emission signal;
a fourth switching TFT configured to interconnect the third node and the anode of the light emitting element in response to the emission signal;
an on-bias TFT configured to apply an on-bias voltage to the first node in response to a third scan signal; and
an initialization TFT configured to apply an initialization voltage to the second node in response to a fourth scan signal.

8. The display device according to claim 7, wherein:
the first anode reset switch applies the first anode reset voltage in response to a fifth scan signal, and
the second anode reset switch applies the second anode reset voltage in response to a sixth scan signal.

9. The display device according to claim 7, wherein:
the first anode reset switch applies the first anode reset voltage in response to a fifth scan signal, and
the second anode reset switch comprises an eighth switching TFT configured to receive the fifth scan signal together with the first anode reset switch, and be turned on and off opposite to the first anode reset switch, and a ninth switching TFT configured to receive the third scan signal together with the on-bias TFT, and be turned on and off identical to the on-bias TFT.

10. The display device according to claim 9, wherein:
the first anode reset switch is a p-type MOSFET (PMOS), and
the eighth switching TFT of the second anode reset switch is an n-type MOSFET (NMOS), and the ninth switching TFT of the second anode reset switch is a PMOS.

11. The display device according to claim 10, wherein:
each of the first switching TFT and the initialization TFT is an NMOS, and
each of the second switching TFT, the third switching TFT, the fourth switching TFT, the second switching TFT, and the on-bias TFT is a PMOS.

12. A method of controlling a display device comprising a plurality of subpixels each having a light emitting element, the method comprising:
performing an operation in a refresh period in which a data voltage is applied to each of the plurality of subpixels; and
performing an operation in a hold period in which the data voltage is maintained,
wherein the operation in the refresh period comprises inputting a first anode reset voltage to an anode of the light emitting element, and the operation in the hold period comprises inputting a second anode reset voltage to the anode of the light emitting element.

13. The method according to claim 12, wherein:
the first anode reset voltage is supplied through a first anode reset voltage supply unit, and
the second anode reset voltage is supplied through a second anode reset voltage supply unit.

14. The method according to claim 12, wherein the first anode reset voltage and the second anode reset voltage have the same voltage level.
